(19) United States
(12) Patent Application Publication
(10) Pub. No.: US 2024/0071652 A1
(43) Pub. Date: Feb. 29, 2024

(54) INSULATOR STRUCTURALLY CONFIGURED TO OPTIMIZE ELECTRIC PERFORMANCE OF A HARDLINE COAXIAL CABLE EXTENDER

(71) Applicant: PPC BROADBAND, INC., East Syracuse, NY (US)

(72) Inventor: Mitch FREDENBURG, East Syracuse, NY (US)

(73) Assignee: PPC BROADBAND, INC., East Syracuse, NY (US)

(21) Appl. No.: 18/240,205

(22) Filed: Aug. 30, 2023

Related U.S. Application Data
(60) Provisional application No. 63/402,358, filed on Aug. 30, 2022.

(51) Int. Cl. H01B 11/18; H01B 3/00

(52) U.S. Cl. CPC H01B 11/1843; H01B 3/004

(57) ABSTRACT

An insulator may include a first insulator portion that is structurally configured to receive a portion of a center conductor portion of a coaxial cable extender and a second insulator portion that is structurally configured to receive at least a portion of the first insulator portion. The second insulator portion may comprise a higher dielectric constant than a dielectric constant of the first insulator portion such that the insulator may be structurally configured to enhance electrical performance of the coaxial cable extender.

### TECHNICAL FIELD

The present disclosure generally relates to extenders and connectors for terminating a coaxial cable. More particularly, the present invention relates to an extender for hardline coaxial cables.

### BACKGROUND

Coaxial cables are commonly used in the cable television industry to carry cable TV signals to television sets in homes, businesses, and other locations. A hardline coaxial cable may be used to carry the signals in distribution systems exterior to these locations and a flexible coaxial cable is then often used to carry the signals within the interior of these locations. Hardline or semi-rigid coaxial cable is also used where a high degree of radio-frequency (RF) shielding is required.

The hardline cable includes a solid wire core or inner conductor, typically of copper or copper-clad aluminum, surrounded by a solid tubular outer conductor. The outer conductor is also usually made of copper or aluminum. Dielectric material or insulation separates the inner and outer conductors. The outer conductor may be covered with a cable jacket or sheath of plastic to provide protection against scratches.

One type of connector for hardline coaxial cables employs radial compression crimping to electrically and mechanically connect parts of the connector to the cable, Typically, a sleeve within the connector is compressed by a crimping tool. The sleeve may have slots, flutes, threads and the like to assist in the mechanical connection between the sleeve and the outer conductor of the cable.

One concern with conventional hardline is the electrical impedance of the radio frequency (RF) signal that is traveling through the terminal pin, collet pin, and the center conductor of the coaxial cable can drop too low or increase too high, which may result in undesirable return losses at the connector. Another concern with conventional hardline connectors is that the pin terminal and the collet pin must be robustly supported such that the pin terminal and collet pin maintain contact within the connectors housing while also allowing the female end of the pin terminal to expand in a radial direction upon insertion of the collet pin into the pin terminal.

Accordingly, it may be desirable to provide an insulator for a hardline coaxial cable extender that provides enhanced structural support for the connection between the pin terminal and collet pin and maintains the electrical impedance of the radio frequency signal at a targeted level in order to reduce return losses that may otherwise incur at or proximate to the extender.

### SUMMARY

In one embodiment of the present disclosure, an insulator may include a first insulator portion and a second insulator portion structurally configured to be received in a bore of a coaxial cable extender. The first insulator portion may include a receiving portion structurally configured to receive a receiving portion of a center conductor portion of a coaxial cable extender, wherein the receiving portion of the center conductor portion of the coaxial cable extender may be structurally configured to radially expand when receiving a center conductor portion of a coaxial cable connector. The first insulator portion may be structurally configured to deform so as to permit radial expansion of the receiving portion of the center conductor portion of the coaxial cable extender, and the second insulator portion may be structurally configured to include a first body portion, a second body portion, an outer flange portion, and a radially extending portion. The first body portion may be structurally configured to extend forward from the outer flange portion, and the second body portion may be structurally configured to extend rearward from the outer flange portion. The radially extending portion may be structurally configured to extend radially outward from an outer perimeter of the first body portion and forward from the outer flange portion, and the second insulator portion may include a receiving portion that is structurally configured to receive at least a portion of the first insulator portion. The first insulator portion may comprise a first material, and the second insulator portion may comprise a second material, wherein the second material comprises a higher modulus of elasticity than the first material such that the second insulator portion may be structurally configured to limit radial expansion of the first insulator portion. The second material may comprise a higher dielectric constant than the first material such that the insulator may be structurally configured to maintain an electrical impedance of a radio frequency signal traveling from a center conductor portion of a coaxial cable connector to the center conductor portion of the coaxial cable extender at a predetermined level to reduce return losses at the coaxial cable extender so as to enhance electrical performance of the coaxial cable extender.

In an exemplary embodiment, an insulator may include a first insulator portion, and a second insulator portion structurally configured to be received in a bore of a coaxial cable extender. The first insulator portion may include a receiving portion structurally configured to receive a receiving portion of a center conductor portion of a coaxial cable extender, wherein the receiving portion of the center conductor portion of the coaxial cable extender may be structurally configured to radially expand when receiving a center conductor portion of a coaxial cable connector. The second insulator portion may include a receiving portion that is structurally configured to receive at least a portion of the first Insulator portion, the first insulator portion may comprise a first material, and the second insulator portion may comprise a second material. The second material may comprise a higher dielectric constant than the first material such that the insulator may be structurally configured to reduce return losses at the coaxial cable extender so as to enhance electrical performance of the coaxial cable extender.

In an exemplary embodiment, an insulator may include a first insulator portion that is structurally configured to receive a portion of a center conductor portion of a coaxial cable extender and a second insulator portion that is structurally configured to receive at least a portion of the first insulator portion. The second insulator portion may comprise a higher dielectric constant than a dielectric constant of the first insulator portion such that the insulator may be structurally configured to enhance electrical performance of the coaxial cable extender.

### BRIEF DESCRIPTION OF THE DRAWINGS

Further advantages and features of the present disclosure will become apparent from the following description and the accompanying drawings, to which reference is made.

FIG. 1A illustrates a side view of an exemplary coaxial extender of the present disclosure,

FIG. 1B illustrates a cross-sectional side view of an exemplary coaxial extender of FIG. 1A.

FIG. 1C illustrates the exemplary coaxial extender of FIG. 1B with a coaxial cable and connector attached to the extender.

FIG. 2 illustrates a partial enlarged isometric view of the housing, first insulator portion, terminal pin, and second insulator portion of the exemplary extender shown in FIG. 1C,

FIG. 3 illustrates an enlarged isometric view of the first insulator portion, second insulator portion, and pin receiver shown in FIG. 2.

FIG. 4 illustrates an isometric view of the first insulator portion and second insulator portion of FIG. 2.

FIG. 5 illustrates an isometric assembly view of the first insulator portion and second insulator portion of FIG. 2.

### DETAILED DESCRIPTION

Reference will now be made in detail to embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

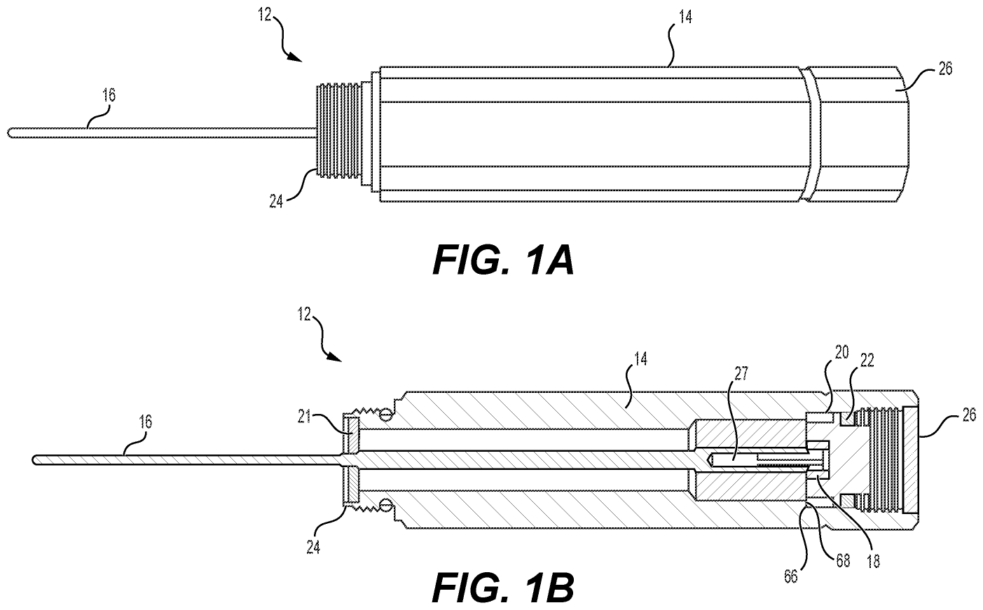

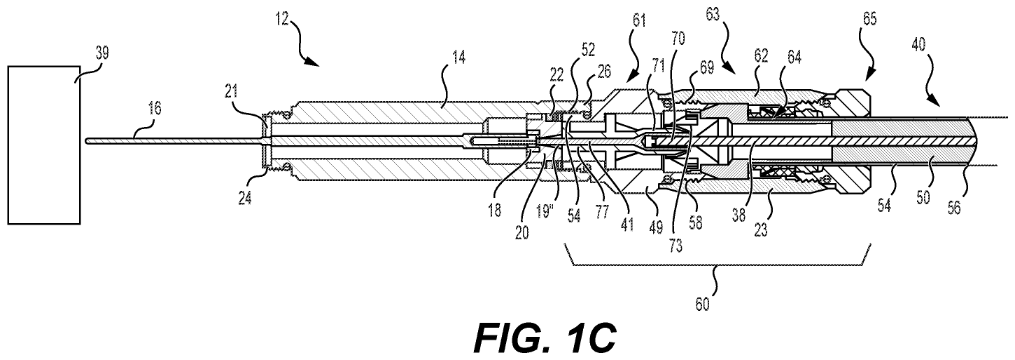

Referring to FIGS. 1A-1C, an exemplary coaxial cable extender 12 in accordance with the present disclosure is depicted. The coaxial cable extender 12 may be structurally configured for use with hardline and/or semi-rigid coaxial cables. The coaxial cable extender 12 is structurally configured to provide both an electrical and mechanical connection between a network device 39 and a coaxial cable 40.

As shown in FIGS. 1A-1C and FIGS. 2-5, the coaxial cable extender 12 of the present disclosure may include a housing 14, a center conductor portion 16, for example, a terminal pin, an insulator 15, and a retaining portion 22. The insulator 15 may include a first insulator portion 18, for example, a flexible support collar, and a second insulator portion 20, for example, an outer insulating collar, structurally configured to surround at least a portion of the first insulator portion. The first insulator portion 18 and the second insulator portion 20 may be separate structures that are structurally configured to be coupled together, for example, via a friction fit or interference fit relationship.

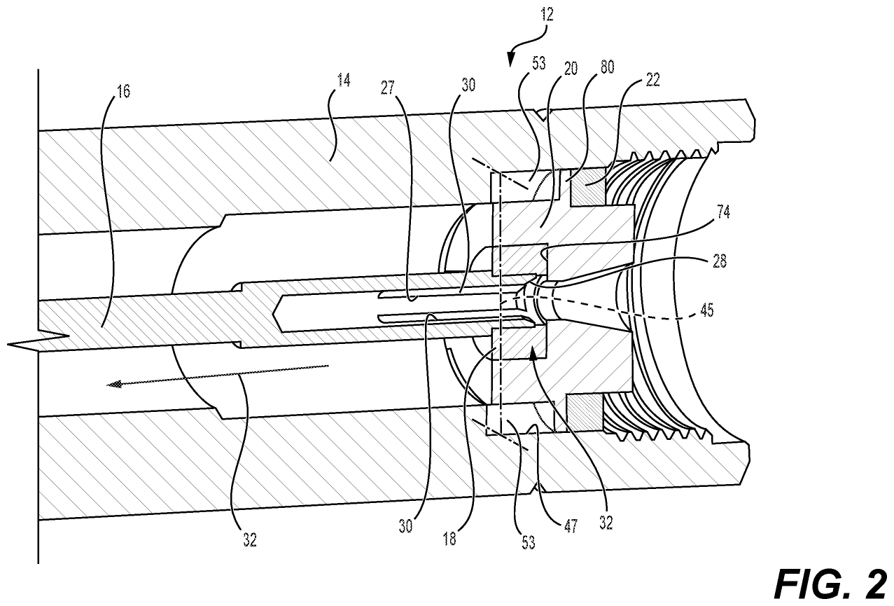

The housing 14 may include a first forward end 24 and a second rearward cable receiving end 26 opposite the first forward end 24. A dust cap 21 may be mounted at the first forward end 24 of housing 14 and may be made from a dielectric material such as plastic and may provide a sea as well as additional support to the terminal pin 16. The terminal pin 16 may include a receiving portion 27 at a rearward end 28 of the terminal pin 16. The receiving portion 27 may be structurally configured to receive a center conductor or collet pin of a coaxial cable connector, for example, a hardline connector, as discussed in more detail below. The receiving portion 27 may include a plurality of axial slots 30 extending from the rearward end 28 in a forward direction 32, as shown in FIG. 2. The axial slots 30 may define a gripping portion 36, for example, a plurality of expandable fingers, that are structurally configured to extend into the first insulator portion 18 such that the first insulator portion 18 is structurally configured to maintain a grip on the center conductor 38, or collet pin, that is structurally configured to be received in the receiving portion 27.

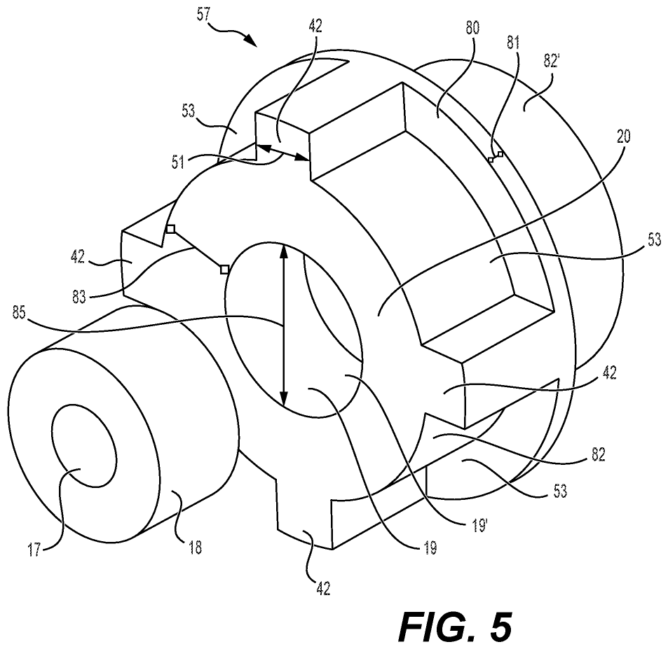

The first insulator portion 18 includes a receiving portion 17, for example, a bore 17, as shown in FIG. 5, that is structurally configured to receive a rearward portion 32 of the terminal pin 16. The second insulator portion 20 may comprise an insulating collar that includes a receiving portion 19, for example, a bore, structurally configured to receive at least a portion of the first insulator portion 18. As shown in FIG. 2, the receiving portion 27 of the second insulator portion 20 may include a forward-facing surface or first insulator portion engagement portion 74 that is structurally configured to abut the first insulator portion 18 in order to prevent the first insulator portion 18 from moving toward the second rearward end 24 of the housing. As later described herein, a retaining portion 22, for example, a metal retaining ring, may be structurally configured to be press fit into a receiving portion 34, for example, a bore, of the housing 14 in order to prevent or limit axial movement of the two-piece insulator 15 in direction towards the second rearward end 26 of the housing 14.

The second insulator portion 20 is structurally configured to be received in the receiving portion 34 of the housing 14. Accordingly, the insulator 15 may be disposed in the bore or receiving portion of the housing 14. The bore 34 may include a shoulder portion 66, as illustrated in FIG. 1B, having a rearward facing surface or second insulator portion engagement portion 68 that is structurally configured to be a forward stop that prevents the insulator 15 from moving towards the first forward end 24 of the housing 14. Accordingly, at least an outer edge region or portion of the second insulator portion 20 of the insulator 15 may be structurally configured to abut the rearward facing surface 68 of the shoulder portion 66. The retaining portion 22 may be structurally configured to prevent or limit axial movement of the insulator 15 in a direction towards the second rearward cable receiving end 26 of the housing 14. (See FIGS. 1C and 2). Accordingly, the insulator 15 may be disposed between the shoulder 66 and the retaining portion 22.

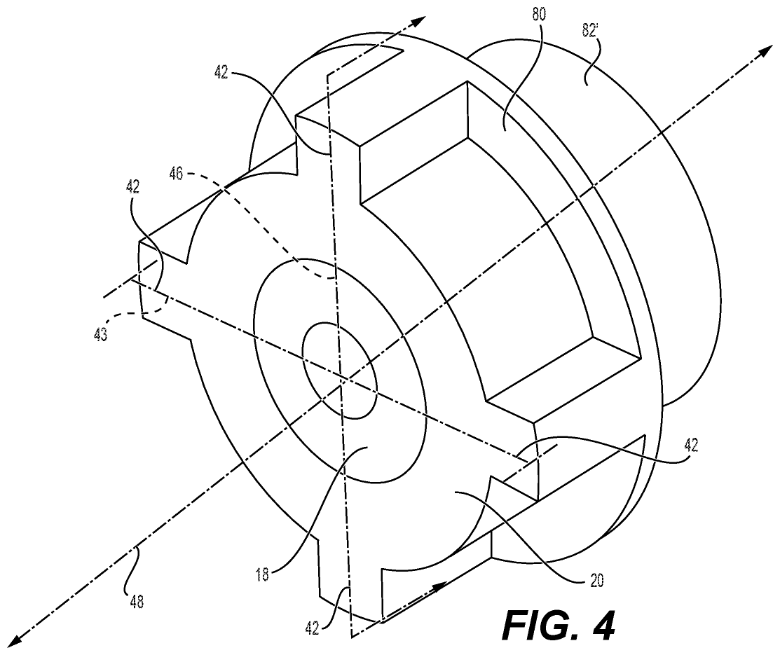

Referring again to FIG. 2, the axial slots 30 may define a plurality of expandable fingers 36 that are structurally configured to define the receiving portion 27. At least a portion of the expandable fingers 36 may be received in the receiving portion or bore 17 of the first insulator portion 18. The first insulator portion 18 may be compressed or flex in a radially outward direction at a region 29 of the first insulator portion along the bore 17 of the first insulator portion 18 as the pin receiver 27 radially expands when the center conductor or collet pin 41 of a coaxial cable connector, for example, a hardline connector is received in the pin receiver 27. The first insulator portion 18 therefore has some flexibility that allows the expandable fingers 36 to expand, but the second insulator portion 20 may be structurally configured to limit the expansion of the first insulator portion 18, which permits the first insulator portion 18 to maintain a tighter grip on the expandable fingers 36 of the receiving portion 27. According to various aspects and as shown in FIGS. 4-5, the first insulator portion 18 may be received by the bore 19 of the second insulator portion 20 in a friction fit or interference fit relationship. As shown in FIGS. 4 and 5, the second insulator portion 20 may be structurally configured to include a first body portion 82, a second body portion 82′, an outer flange portion 80, and a radially extending portion 42. The first body portion 82 may be structurally configured to extend forward from the outer flange portion 80, and the second body portion 82′ may be structurally configured to extend rearward from the outer flange portion 80. The radially extending portion 42 may be structurally configured to extend radially outward from an outer perimeter of the first body portion 82 and forward from the outer flange portion 80.

For example, the radially extending portion 42 may comprise a plurality of radially extending structures 42′, such as, for example, a plurality of fins integral to an exterior surface 44 of the second insulator portion 20 such that a plane 46 (defined by each fin 42′ in the plurality of fins) intersects with an axis 48 of the second insulator portion 20 and the first insulator portion 18.

As shown in FIG. 5, the first body portion 82 and the second body portion 82′ may each be structurally configured as a tubular body portion. In some aspects, the first body portion 82, the second body portion 82′, the outer flange portion 80, and the radially extending portion 42 may be structurally configured as a monolithic body 57 of unitary construction.

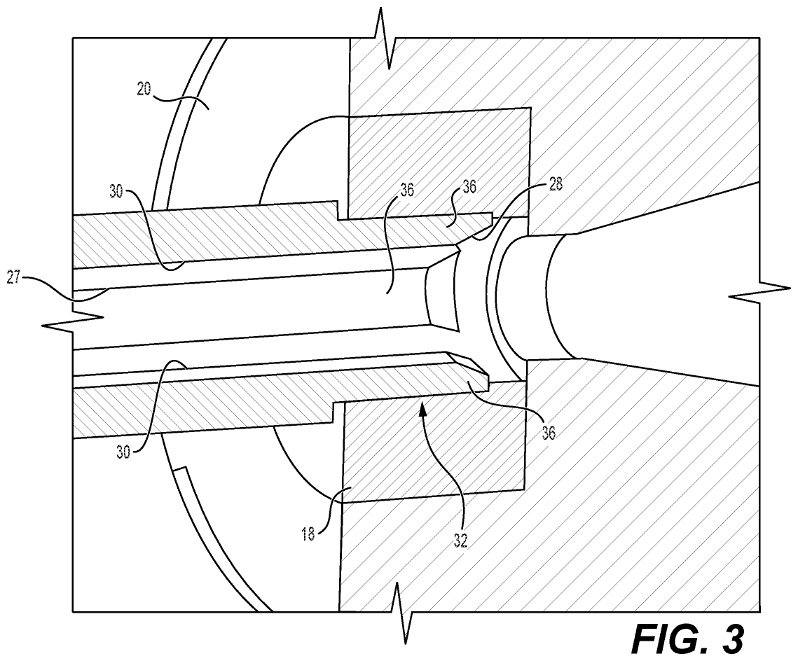

The first body portion 82 and the second body portion 82 are structurally configured to define the bore 19, which may have a varying diameter as described herein. As best illustrated in FIGS. 2 and 3, the first body portion 80 may define a fixed diameter portion 19′ of the bore 19, and the second body portion 82′ may define a tapered portion 19″ of the bore 19.

With respect to the second insulator portion 20 of the present disclosure, the outer diameters of the first tubular portion 82 (or first tubular body 82) and the second tubular portion 82′ (or second tubular body 82′) can be the same or different and are both smaller than an outer diameter of the outer flange portion 80. The outer diameter of the second tubular portion 82′ depends in part on the thickness of the retaining portion 22 of the coaxial cable extender 12. In the exemplary embodiment shown in FIG. 2, the thickness of the retaining ring 22 requires that the second body portion 82′ have a slightly smaller outer diameter compared to an outer diameter of the first body portion 82 (or first tubular body 82).

The first insulator portion 18 comprises a first material, and the second insulator portion 20 comprises a second material. The second material possesses a higher dielectric constant than the first material such that the insulator 15 is structurally configured to maintain an electrical impedance of a radio frequency signal traveling from a center conductor portion 41 of a coaxial cable connector 60 to the center conductor portion 16 of the coaxial cable extender 12 at a predetermined level to reduce return losses at the coaxial cable extender 12 so as to enhance electrical performance of the coaxial cable extender 12.

In some embodiments, the second material used to form the second insulator portion 20 may have a higher modulus of elasticity relative to the first material used to form the first insulator portion 18 so to reduce the risk of creep, thereby maintaining robust support between the terminal pin 16 and the collet pin 41, That is, the second insulator portion 20 comprises a stiffer material than that of the first insulator portion 18 As a result, as previously indicated, the second insulator portion 20 may limit the expansion of the first insulator portion 18 such that the first insulator portion 18 is structurally configured to urge the receiving portion 27 of the terminal pin portion 16 to grip the center conductor portion 41 of the coaxial cable connector 60. Thus, first insulator portion 18 is structurally configured to grip the center conductor portion 16 of the coaxial cable extender 12. In one example, the second insulator portion 20 may, but not necessarily, comprise Delrin, and the first insulator portion 18 may, but not necessarily, comprise Teflon, given that Delrin better reduces electrical impedance of the radio frequency signal passing through the center conductor 38 and the terminal pin 16 and the collet pin 41, On the other hand, Teflon is structurally configured to flex or compress more than Delrin, such that when a diameter of the receiving portion 27 increases when the collet pin 41 is inserted into the pin receiver 27, the first insulator portion is structurally configured to flex or be compressed radially outward, but the flex or compression of the first insulator portion is limited by the stiffer material of the second insulator portion.

Referring to FIGS. 2 and 4, the outer diameter 43 of the fins 42 are substantially equal to the inner diameter 45 of the main housing 14 in order to help keep the second insulator portion 20 centered in the bore in the main housing 14. Each fin 42 may be perpendicular to an inner surface 47 of the receiving structure or bore 34 of the main housing 14 and may be spaced apart about the first body portion 82 in a circumferential direction, Referring to FIG. 5, the second insulator portion 20 is structurally configured to define a recess 53 between each pair of fins 42 in order to reduce the amount of dielectric material used in this insulator such that the connector could be better tuned to reach 75 Ohms. It is understood that it may not be desirable to make the impedance go below 75 Ohms, which could occur in the event there is excessive dielectric material in the second insulator portion 20. However, insufficient dielectric material in the second insulator portion 20 could also make the electrical impedance go above 75 Ohms, which may also be undesirable. Therefore, in order to tune the dielectric material of the second insulator portion 20, the width 51 of each fin 42 may, for example, be increased or decreased, which, in turn, also changes the width of each recess. Accordingly, the size of the fins 42 and the recesses 53 may be adjusted/varied in order to ensure that the desired electrical impedance is achieved.

As shown in FIG. 5, the plurality of fins 42 may be structurally configured to be substantially perpendicular to the outer flange portion 80. Moreover, the outer flange portion 80 may also be disposed perpendicular to the plurality of fins 42 wherein the axial dimension 81 of the outer flange 80 may also be increased (to increase the amount of dielectric material) or decreased (to decrease the amount of dielectric material) in order to ensure that the desired electrical impedance is achieved. Also, as shown in FIG. 5, the outer flange portion 80 may be disposed between the first and second body portions 82, 82′, wherein a wall thickness 83 of the first body portion 82 may be adjusted (increased or decreased) while maintaining a width of the diameter 85 of the fixed diameter portion 19′ of the bore 19 of the second insulator portion 20 in order to ensure that the desired electrical impedance is achieved. When the desired electrical impedance is achieved, the return loss performance of the coaxial cable extender 12 is optimized. For purposes of cable televisions, it is understood that it is generally desired to achieve an electrical impedance of 75 ohms.

In order to connect the coaxial cable extender 12 and coaxial cable 40 with a network device 39, the coaxial cable extender 12 may, for example, be threaded into a female port (not shown) of the network device 39 at the forward first end of the extender 12. The connector 60 may include a front body assembly 61, a midbody assembly 63, and a back nut assembly 65. The front body assembly 61 includes the collet pin 41, an insulating spool 77, and a housing 49, wherein the insulating spool 77 is disposed within a bore of the housing 49. The insulating spool 77 may, but not necessarily, be made from a material such as polyetherimide. The insulating spool 77 may be structurally configured to affix the collet pin 41 within the housing 49 of the front body assembly 61.

As the front body assembly 61 is threaded onto the extender 12, the collet pin 41 is inserted into the receiving portion 27 thereby expanding the receiving portion 27 as previously described above. As shown in FIG. 1C, the housing 14 includes a rearward internally threaded portion 52 that is structurally configured to cooperate with a forward threaded portion 54 of the front body assembly 61. However, before mechanically coupling the center conductor 38 of the coaxial cable 40 to the collet pin 41, the end of the coaxial cable 40 must be prepared. Cable preparation entails removing about 0.75 inch (19.05 mm.) of cable dielectric 50, outer cable conductor 56 (or outer shield 56) to expose the portion 70 of the center conductor 38 that will engage the collet pin extensions 71. After the cable end is prepared, it is inserted through the back nut assembly 63 and the midbody assembly 61. As the midbody assembly is threaded onto the front body assembly 61, the seizure bushing 73 compresses onto distal end 75 of insulating spool 77, collet pin extensions 71, and the center conductor 38 of the coaxial cable as shown in FIG. 1C so that the portion 70 of the center conductor 38 is engaged or gripped by the collet pin extensions 71. As a result, the terminal pin 16 is in electrical communication with the center conductor 38 as the midbody assembly 63 is threaded onto the housing 49 for the front body assembly 61. Once the midbody assembly 63 is threaded onto the front body assembly 61, the back nut assembly 65 may be threaded onto the midbody assembly 63.

The coaxial cable 40 generally includes a center conductor 38 structurally configured to provide electrical signals there through. Center conductor 38 is typically formed from a conductive metal, such as copper, copper clad aluminum, copper clad steel and the like. Surrounding the center conductor 38 is a cable dielectric 50 which insulates the center conductor 38 to minimize signal loss. The cable dielectric 50 also maintains a spacing between the center conductor 38 and a cable outer conductor 56 (or outer shield 56). The cable dielectric 50 is often a plastic material, such as a polyethylene, a fluorinated plastic material, such as a polyethylene or a polytetrafluoroethylene, a fiberglass braid and the like. The cable shield or outer cable conductor 56 is typically made of metal, such as aluminum or steel, and is often extruded to form a hollow tubular structure with a solid wall having a smooth exterior surface. An insulative cable jacket (not shown) may surround the outer cable conductor 56 to further seal the coaxial cable 40 and is typically made of plastic, such as polyvinylchloride, polyethylene, polyurethane, polytetrafluoroethylene and the like.

The midbody assembly 63 may include a housing 62 having an axial bore and a compression subassembly 64 rotatably supported within the axial bore. The compression subassembly 64 may include the seizure bushing 73 as previously described. The compression assembly 64 may be structurally configured to prevent the coaxial cable 40 from moving in a rearward direction once the midbody assembly 63 has been threaded onto the front body assembly 61. The midbody housing 62 is made from an electrically conductive material, such as aluminum, brass, or the like, and includes a forward internally threaded portion 58 that cooperates with the rearward threaded portion 69 of the front body assembly 61 so that the front body assembly 61 and midbody housing 62 may be threadedly coupled together. The exterior surface 23 of the midbody housing 62 is preferably provided with a hexagonal shape to accommodate the use of tools to facilitate such threaded coupling. The midbody housing 62 is structurally configured to be rotated with respect to the coaxial cable 40 to allow the cable 40 to be installed.

While at least one example, non-limiting embodiment has been presented in the foregoing detailed description, it should be appreciated that a vast number of variations exist. It should also be appreciated that the exemplary embodiment or exemplary embodiments are only examples and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An insulator structurally configured to enhance electrical performance of a coaxial cable extender comprising:
a first insulator portion;
a second insulator portion structurally configured to be received in a bore of a coaxial cable extender;
wherein the first insulator portion includes a receiving portion structurally configured to receive a receiving portion of a center conductor portion of a coaxial cable extender, wherein the receiving portion of the center conductor portion of the coaxial cable extender is structurally configured to radially expand when receiving a center conductor portion of a coaxial cable connector;
wherein the first insulator portion is structurally configured to deform so as to permit radial expansion of the receiving portion of the center conductor portion of the coaxial cable extender;
wherein the second insulator portion is structurally configured to include a first body portion, a second body portion, an outer flange portion, and a radially extending portion;
wherein the first body portion is structurally configured to extend forward from the outer flange portion, and the second body portion is structurally configured to extend rearward from the outer flange portion;
wherein the radially extending portion is structurally configured to extend radially outward from an outer perimeter of the first body portion and forward from the outer flange portion;
wherein the second insulator portion includes a receiving portion that is structurally configured to receive at least a portion of the first insulator portion;
wherein the first insulator portion comprises a first material and the second insulator portion comprises a second material, and wherein the second material comprises a higher modulus of elasticity than the first material such that the second insulator portion is structurally configured to limit radial expansion of the first insulator portion; and
wherein the second material comprises a higher dielectric constant than the first material such that the insulator is structurally configured to maintain an electrical impedance of a radio frequency signal traveling from a center conductor portion of a coaxial cable connector to the center conductor portion of the coaxial cable extender at a predetermined level to reduce return losses at the coaxial cable extender so as to enhance electrical performance of the coaxial cable extender.

2. The insulator of claim 1, wherein the radially extending portion includes a plurality of radially extending structures that are spaced apart from one another circumferentially about the outer perimeter of the first body portion.

3. The insulator of claim 1, wherein the first body portion comprises a first tubular body portion and the second body portion comprises a second tubular body portion.

4. The insulator of claim 1, wherein an outer perimeter of the radially extending portion matches the outer periphery of the flange portion; and
wherein an outer perimeter of the flange portion is greater than an outer perimeter of the first body portion and the outer perimeter of the first body portion is greater than an outer perimeter of the second body portion.

5. The insulator of claim 1, wherein the receiving portion of the second insulator portion is structurally configured to receive the at least a portion of the first insulator portion in a friction fit relationship.

6. A coaxial cable extender comprising:
a housing portion structurally configured to include a first forward end that is structurally configured to receive the insulator of claim 1, and a second rearward cable receiving end opposite the first forward end;
a terminal pin portion structurally configured to include a receiving portion at a rearward end thereof;
wherein the receiving portion of the terminal pin portion is structurally configured to expand to receive a center conductor portion of a coaxial cable connector;
wherein the first insulator portion is structurally configured to permit expansion of the receiving portion of the terminal pin portion; and
wherein the second insulator portion is structurally configured to limit radial expansion of the first insulator portion such that the first insulator portion is structurally configured to urge the receiving portion of the terminal pin portion to grip the center conductor portion of the coaxial cable connector.

7. An insulator structurally configured to enhance electrical performance of a coaxial cable extender comprising:
a first insulator portion;
a second insulator portion structurally configured to be received in a bore of a coaxial cable extender;
wherein the first insulator portion includes a receiving portion structurally configured to receive a receiving portion of a center conductor portion of a coaxial cable extender, wherein the receiving portion of the center conductor portion of the coaxial cable extender is structurally configured to radially expand when receiving a center conductor portion of a coaxial cable connector;
wherein the second insulator portion includes a receiving portion that is structurally configured to receive at least a portion of the first insulator portion;
wherein the first insulator portion comprises a first material and the second insulator portion comprises a second material; and
wherein the second material comprises a higher dielectric constant than the first material such that the insulator is structurally configured to reduce return losses at the coaxial cable extender so as to enhance electrical performance of the coaxial cable extender.

8. The insulator of claim 7, wherein the insulator is structurally configured to maintain an electrical impedance of a radio frequency signal traveling from a center conductor portion of a coaxial cable connector to the center conductor portion of the coaxial cable extender at a predetermined level.

9. The insulator of claim 7 wherein the second insulator portion is structurally configured to include a first body portion, a second body portion, an outer flange portion, and a radially extending portion;
wherein the first body portion is structurally configured to extend forward from the outer flange portion, and the second body portion is structurally configured to extend rearward from the outer flange portion; and
wherein the radially extending portion is structurally configured to extend radially outward from an outer perimeter of the first body portion and forward from the outer flange portion;

10. The insulator of claim 9, wherein the radially extending portion includes a plurality of radially extending structures that are spaced apart from one another circumferentially about the outer perimeter of the first body portion.

11. The insulator of claim 9, wherein the first body portion comprises a first tubular body portion and the second body portion comprises a second tubular body portion.

12. The insulator of claim 9, wherein an outer perimeter of the radially extending portion matches the outer periphery of the outer flange portion; and
wherein an outer perimeter of the flange portion is greater than an outer perimeter of the first body portion, and the outer perimeter of the first body portion is greater than an outer perimeter of the second body portion.

13. The insulator of claim 7, wherein the receiving portion of the second insulator portion is structurally configured to receive the at least a portion of the first insulator portion in a friction fit relationship.

14. The insulator of claim 7, wherein the first insulator portion is structurally configured to deform so as to permit radial expansion of the portion of the center conductor portion of the coaxial cable extender; and
wherein the second material comprises a higher modulus of elasticity than the first material such that the second insulator portion is structurally configured to limit radial expansion of the first insulator portion.

15. A coaxial cable extender comprising:
a housing portion structurally configured to receive the insulator of claim 7.

16. The coaxial cable extender of claim 15, further comprising a center conductor portion structurally configured to include a receiving portion at a rearward end thereof; and
wherein the receiving portion of the center conductor portion of the coaxial cable extender is structurally configured to expand radially to receive a center conductor portion of a coaxial cable connector.

17. The coaxial cable extender of claim 16, wherein the first insulator portion is structurally configured to permit radial expansion of the receiving portion of the center conductor portion of the coaxial cable extender; and
wherein the second insulator portion is structurally configured to limit radial expansion of the first insulator portion such that the first insulator portion is structurally configured to urge the receiving portion of the center conductor portion of the coaxial cable extender to grip the center conductor portion of the coaxial cable connector.

18. The coaxial cable extender of claim 16, wherein the receiving portion of the center conductor portion of the coaxial cable extender comprises a terminal pin.

19. An insulator structurally configured to enhance electrical performance of a coaxial cable extender comprising:
a first insulator portion;
a second insulator portion;
wherein the first insulator portion is structurally configured to receive a portion of a center conductor portion of a coaxial cable extender;
wherein the second insulator portion is structurally configured to receive at least a portion of the first insulator portion; and
wherein the second insulator portion comprises a higher dielectric constant than a dielectric constant of the first insulator portion such that the insulator is structurally configured to enhance electrical performance of the coaxial cable extender.

20. The insulator of claim 19, wherein the insulator is structurally configured to maintain an electrical impedance of a radio frequency signal traveling from a center conductor portion of a coaxial cable connector to the center conductor portion of the coaxial cable extender at a predetermined level.

21. The insulator of claim 19, wherein the second insulator portion is structurally configured to include a first body portion, a second body portion, an outer flange portion, and a radially extending portion;
wherein the first body portion is structurally configured to extend forward from the outer flange portion, and the second body portion is structurally configured to extend rearward from the outer flange portion; and
wherein the radially extending portion is structurally configured to extend radially outward from an outer perimeter of the first body portion and forward from the outer flange portion;

22. The insulator of claim 21, wherein the radially extending portion includes a plurality of radially extending structures that are spaced apart from one another circumferentially about the outer perimeter of the first body portion.

23. The insulator of claim 21, wherein the first body portion comprises a first tubular body portion and the second body portion comprises a second tubular body portion.

24. The insulator of claim 21, wherein an outer perimeter of the radially extending portion matches the outer periphery of the outer flange portion; and
wherein an outer perimeter of the flange portion is greater than an outer perimeter of the first body portion, and the outer perimeter of the first body portion is greater than an outer perimeter of the second body portion.

25. The insulator of claim 19, wherein the receiving portion of the second insulator portion is structurally configured to receive the at least a portion of the first insulator portion in a friction fit relationship.

26. The insulator of claim 19, wherein the first insulator portion is structurally configured to deform so as to permit radial expansion of the portion of the center conductor portion of the coaxial cable extender; and
wherein the second insulator portion comprises a higher modulus of elasticity than a modulus of elasticity of the first insulator portion such that the second insulator portion is structurally configured to limit radial expansion of the first insulator portion.

27. A coaxial cable extender comprising:
a housing portion structurally configured to receive the insulator of claim 19.

28. The coaxial cable extender of claim 27, further comprising a center conductor portion structurally configured to include a receiving portion at a rearward end thereof; and
wherein the receiving portion of the center conductor portion of the coaxial cable extender is structurally configured to expand radially to receive a center conductor portion of a coaxial cable connector.

29. The coaxial cable extender of claim 28, wherein the first insulator portion is structurally configured to permit radial expansion of the receiving portion of the center conductor portion of the coaxial cable extender; and
wherein the second insulator portion is structurally configured to limit radial expansion of the first insulator portion such that the first insulator portion is structurally configured to urge the receiving portion of the center conductor portion of the coaxial cable extender to grip the center conductor portion of the coaxial cable connector.

30. The coaxial cable extender of claim 28, wherein the receiving portion of the center conductor portion of the coaxial cable extender comprises a terminal pin.
